(19) United States
(12) Patent Application Publication
(10) Pub. No.: US 2016/0196735 A1
(43) Pub. Date: Jul. 7, 2016

(54) Systems and Methods for Monitoring Health in a Shared Living Environment

(71) Applicant: Adam Clayman, University Heights, OH (US)

(72) Inventor: Adam Clayman, University Heights, OH (US)

(21) Appl. No.: 14/874,435

(22) Filed: Oct. 4, 2015

Related U.S. Application Data
(60) Provisional application No. 62/099,456, filed on Jan. 3, 2015.

(51) Int. Cl. G08B 25/01

(52) U.S. Cl. CPC G08B 25/016

(57) ABSTRACT

The systems and method for monitoring health in a shared living environment may provide a collection of components and/or accessories that may, in various aspects, assist in deterring sexual coercion, sexual assault, and rape, provide a rapid response pathway in the event of sexual coercion or assault, stimulate and support event reporting by complainants, reduce false positive and false negative rates (for both accused and accusers), and/or enable later differentiation between meritorious and meretricious complainants and counter complainants (defendants/respondents) in future disciplinary or legal proceedings. In addition, other aspects of the systems and method described herein may assist in monitoring promoting other healthy lifestyle choices, such as sleep and study choices.

### RELATED APPLICATIONS

This application claims priority under 35 U.S.C. §119(e) of provisional application Ser. No. 62/099,456, filed Jan. 3, 2015, the disclosure of which is incorporated herein by reference.

### TECHNICAL FIELD

The present application generally relates to systems and methods that may assist in the prevention, deterrence, reporting, and response to sexual coercion, sexual assault, and rape, in any environment or setting, and particularly those in shared living environments including a bed. The systems and methods are further enriched by supporting healthy lifestyle choices, such as health sleep scheduling.

### RELATED ART

On Sep. 14, 2014, Lilly Jay, Vice-President Joe Biden, and President Barrack Obama announced the launch of the “It's On US” (i.e. the “It's on the United States” and “It's on Us [1st Person Plural]”) Campaign to End Campus Sexual Assault. Present systems and methods for responding to an alleged assault are inadequate for a variety of reasons. For example, if an assault takes place on weekend (as may be typical), it may take anywhere from 8-48 hours, if not days or weeks for word of the sexual assault to reach the Title IX, student conduct, and/or campus police office as very few victims are ready to take their complaint about an acquaintance's coercive approach to sex to the uniformed police in the early morning on a weekend. As a result, only a small number of assaults are ever reported or handled properly. If the initial reporting does not happen immediately, it may not happen at all, as victims of sexual assault take on self-blame and struggle with the total responsibility of how a sexual assault report might affect the life of a classmate that they still perceive, in their own moral calculus, as carrying some positive or other compensating or competing qualities. Thus, it is no surprise that victims vacillate and/or dilate over such a weighty decision, particularly when they may resist labelling their experience as rape, for fear of what it might mean for a person whom they once only a night or two before found lovable.

Rape whistles do not offer much help. The problem with a rape whistle is that it is highly impractical as a countermeasure against the vast majority of sexual coercions and assaults. Smartphone apps have come into existence that attempt to support conscientious (multi-party and increasingly culturally-sound scientific) consent reasoning, but there are serious cultural and procedural flaws with relying on a smartphone for consent retraction. For example, by administering the Good2Go App, a romantic partner may effectively be interrupting the natural flow of the courtship experience and inserting an obstacle in the path of a suitor, presenting themselves as paranoid, for wanting or needing an electronic confirmation of consent from their potential partner.

Further, suppose the consent record entry in an application like Good2Go takes place at a party, before heading to your newfound lover's (or your aroused assailant's) dorm room. Now there's an indelible electronic record that you gave consent for this encounter, but there are no records generated showing your resistance to coercion or advances while in bed. The benefits of Good2Go and all other fully-smartphone-reliant solutions are also diminished in a typical romantic encounter where any of the following conditions may occur: your pants are off and the phone is on the floor; your phone is locked and too time-consuming to access; your smartphone must be fished out of your pocket at a party, raised to chest-level, unlocked, the right app must be located, launched, and loaded, at which point you must navigate through several screens; you are trying to defend yourself from a forceful or violent assailant; or you are using your hands to gesture to make yourself understood to a verbally abusive or verbally coercive aroused acquaintance. As a result, smartphone-based reporting is ineffective.

Accordingly, a need has long existed for improved systems and methods for lung expansion monitoring health in a shared living environment.

### SUMMARY

The systems and method for monitoring health in a shared living environment my provide a collection of components and/or accessories that may, in various aspects, assist in deterring sexual coercion, sexual assault, and rape, provide a rapid response pathway in the event of sexual coercion or assault, stimulate and support event reporting by complainants, drop the false positive and false negative rate (for both accused and accusers), and/or enable later differentiation between meritorious and meretricious complainants and counter complainants (defendants/respondents) in any future disciplinary proceedings. In addition, other aspects of the systems and method described herein may assist in monitoring promoting other healthy lifestyle choices, such as sleep and study choices.

In one aspect, a system for monitoring health information of a user in a shared living environment may include a local hub including a first software module that includes instructions stored on a non-transitory computer readable medium that may receive an alert signal indicative of a request from the user for assistance with an unwanted sexual advance, and may transmit, to a server computer and in response to receiving the alert signal, a request signal indicative of the request for assistance. The server computer may include a second software module that includes instructions stored on a non-transitory computer readable medium that may contact, in response to receiving the request signal, a consent first responder that is trained to handle sexually assaults to assist the user.

Other systems, methods, features and technical advantages of the invention will be, or will become apparent to one with skill in the art upon examination of the following figures and detailed description. It is intended that all such additional systems, methods, features and technical advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 shows an exemplary physical architecture for an exemplary system for monitoring consent;

FIG. 2 shows an exemplary configuration of local hubs in an exemplary dorm room environment;

FIG. 3 shows an exemplary peripheral device for use in an exemplary consent monitoring system;

FIGS. 4a-b show additional exemplary peripheral devices for use in an exemplary consent monitoring system;

FIG. 5 shows an exemplary output device for use with a local hub in an exemplary consent monitoring system;

FIG. 6 shows an exemplary functional architecture for an exemplary consent monitoring system; and

FIG. 7 shows an exemplary flow chart showing the response of a health monitoring server to information from a hub and/or peripheral device.

### DETAILED DESCRIPTION OF THE PREFERRED EMBODIMENTS

The elements illustrated in the Figures interoperate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the contact management system architecture may be stored on, distributed across, or read from other machine-readable media, for example, secondary storage devices such as hard disks, floppy disks, and CD-ROMs; a signal received from a network; other forms of ROM or RAM either currently known or later developed; and the like.

Furthermore, although specific components of the communications architecture will be described, methods, systems, and articles of manufacture consistent with the contact management system architecture may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, and other data structures may be separately stored and managed, may be incorporated into a single memory or database, may be distributed, or may be logically and physically organized in many different ways, including unstructured data. Programs may be parts of a single program, separate programs, or distributed across several memories and processors. Systems may be implemented in hardware, software, or a combination of hardware and software in one processing system or distributed across multiple processing systems.

Furthermore, although exemplary systems and scenarios are described in a university setting, the systems and methods described herein may be useful in a variety of other locations that may or may not include shared spaces, such as single family homes, apartment complexes, military housing, and the like.

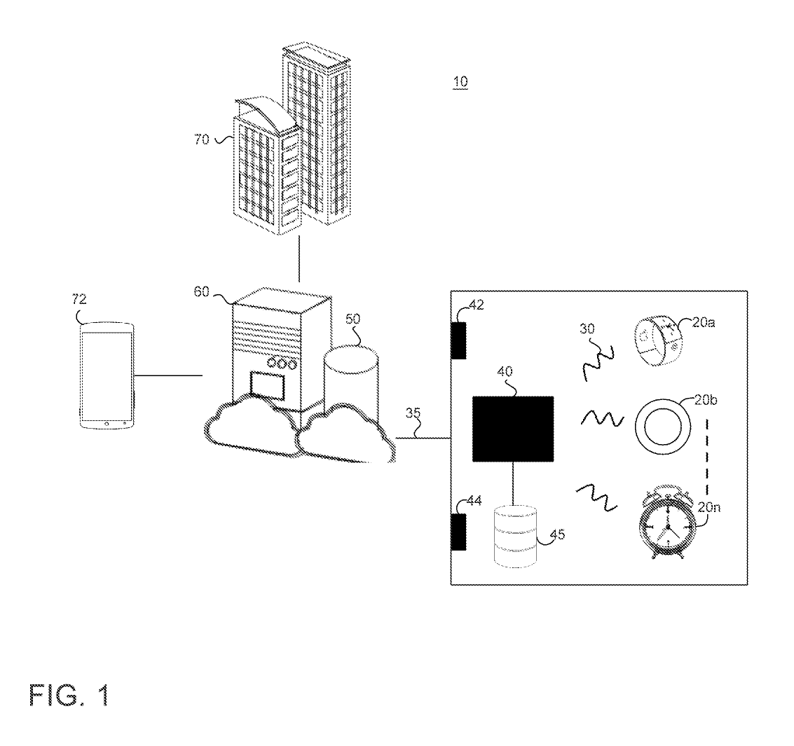

Referring to FIG. 1, an exemplary architecture 10 for a system for monitoring health in a shared living environment is shown. One or more peripheral devices 20a-n may communicate with a local hub 40 via a communications network 30. The peripherals 20a-n may provide input to the hub 40, such as input indicative of an alert, a request for help, or the like. In response, the hub 40 may communicate with a health monitoring server 60 (also referred to herein as a consent monitoring server or server) over a second communications network 35. The health monitoring server 60 may log the alert and/or trigger a response based on the received communication, such as transmitting that alert to a response service provider 70 or directly contacting a responder 72.

In some embodiments, the hub 40 also may trigger a response such as enabling a light 42, generating an audio signal via a speaker 44, or contacting one or more response professionals. The hub 40 and the consent monitoring server 60 may store information in databases 45 and 50, respectively.

Although references will now be made to specific components of the system performing specific features, it should be apparent to one of ordinary skill in the art that such references are exemplary and are not intended to limit the scope of the claims in any way; furthermore, the functionalities described herein may be implemented in a virtually unlimited number of configurations. For example, although figuratively attached to the consent monitoring server 60, the database 50 may, in practice, distribute user-specific data elements directly to one or more local hubs 40. Similarly, the consent monitoring server 60 may be implemented as a single server configured to provide all of the system's functionalities, or the functionalities may be implemented across multiple servers.

The peripheral devices 20a-n may provide a user interface for the system 10 and may couple to and communicate various information with the local hub 40 via a communications network 30. Exemplary peripheral devices 20a-n may include smartwatches 20a, consent bands (wristbands with embedded electronic), alarm clocks 20n, single- or multi-function buttons 20b, belts with integrated (and optionally detachable) transmitter or transceiver and the like. gravity bands, bed buttons, harnesses, sex-toys, alarm clocks, headboards, mattresses (buttons on pad surface, knock tuned within stuffing), bed frames, bed feet, bed footing (knock sensors, “kick in tires” start, anklets, apparel and other wearables, button-enabled beds, with any fixture techniques, floorboard actuations, stomp sensor or bed touchpoint pressure sensor, wall embeds, desk panels, bedside panels bed posters, RF capable “crunch” condoms that signal on “crack”/“tear” opening, GOOGLE GLASS, OCULUS or other VR headband attachment cites, sites, sights, police headgear, p.p.s. apparel and wearable plug-ins. In other words, peripheral devices 20a-n may be any type of device that may provide input to the local hub 40.

Two specific examples are now explained in additional detail. The consent bands may be user devices that are generally more affordable than smartwatches, and carry special features that add confidence in a bedroom over the accessibility of green, blue, and red modal changes in response to the behavior pattern of any other person who may be in the bedroom. Gravity bands, and gravity consent bands, may be user devices that additionally integrate with a user's smartphone and GPS or other local or hyperlocal positional information so as to privately, or in coordination with the university. The gravity bands or gravity consent bands may exchange “hot” “cold” significations through any means known in the art, such as via LEDs that may use the ROYGBIV scale, with movement across the scale in the “attraction” case indicating hot to cold. Similarly, in the case of an assault or other problematic condition, the opposite scale may be used. The bands may exchange data according to established standards, enabling student mobility and environmental security even in the midst of a timely or untimely most innocent, more innocent progression.

In some embodiments, the peripheral devices 20a-n may primarily perform the function of acting as an easily accessible and/or wireless sleep timer and/or panic button with an additional set of programmable indicator lights, including those labelled 1, 2, 3 (for possible applications such as automated “periodic pleasure checks” operated from a low-cost wearable peripheral, or other health applications like interactive pairing with a bluetooth toothbrush or wireless toothbrush/floss kit-storage-assembly-with-electronic-timers for daily or consecutive day habit tracking, like gym trips, athletic exposures, or meeting your METs, with the heavy lifting for measuring, accounted, and validated separately).

Each peripheral device 20a-n may be associated with a user so that they may be used to identify at least one of the two persons involved to help in the issuance of an alert. The peripheral device 20a-n may pair with a local hub 40 or another peripheral device, such as through BLUETOOTH, ZIGBEE or the like. In the event that a peripheral device 20a-n (such as wristband or smartwatch) is paired only with another mobile peripheral device 20a-n (such as a cell phone), the room where the band is instantly located may be identified through any of the following techniques: QR Code Scan from the phone, NFC tag recognition from the paired phone or wristband, ultrasound signature pairing, or through inference by way of local radio network strengths, or any other system of pairing known in the art. The peripheral device 20a-n and/or local hub 40 may include display projection technology, and can also include interactivity through digital or other muscular manipulations.

In some embodiment, peripheral devices 20a-n may comprise stand-alone applications which may be either platform dependent or platform independent. For example, peripheral devices 20a-n may be stand-alone applications for a mobile phones and/or smartwatches configured to run on a mobile operating system such as the iOS™ operating system from Apple Inc. located in Cupertino, Calif., the Android™ operating system from Google, Inc. located in Mountain View, Calif., or the like. Alternatively, or additionally, one or more of the client systems 20a-n may be an application configured to run on mobile computer such as a laptop computer, handheld computer, tablet, mobile messaging device, or the like which may all utilize different hardware and/or software packages. Other peripheral devices 20a-n also may be coupled to the local hub 40.

The communications network 30 may be any wired or wireless communications network. In some embodiments, the local hub 40 and the peripheral devices 20a-n may include wireless chipset/antennae and can communicate (transmit and receive) information over a server/client or mesh network architecture through wireless broadband, an ethernet connection, radio frequency (optionally with short-range RFID tags), Bluetooth, Near Field Communication (NFC), and/or other wireless technologies. In some embodiments, the local hub 40 and/or peripheral devices 20a-n may include Power-Line Communication (PLC). These communication patterns may be organized in traditional wired or wireless networks or with mesh networking, including the use of BATMAN ad-hoc alerts. In some embodiments, the local hub 40 may communicate using the iBeacon™ communication protocol provide by Apple, Inc. of Cupertino, Calif.

In some embodiments, a peripheral device 20a-n may communicate with the server 60 directly (i.e. without the use of a local hub 40). In those embodiments, the communications network 30 may be a cellular network such as, for example, a Code Division Multiple Access (CDMA) network, Global System for Mobiles (GSM) network, General Packet Radio Service (GPRS) network, cdmaOne network, CDMA2000 network, Evolution-Data Optimized (EV-DO) network, Enhanced Data Rates for GSM Evolution (EDGE) network, Universal Mobile Telecommunications System (UMTS) network, Digital Enhanced Cordless Telecommunications (DECT) network, Digital AMPS (IS-136/TDMA), Integrated Digital Enhanced Network (iDEN) and the like.

Local hubs 40 may provide a gateway for one or more peripheral devices 20a-n to the consent monitoring server 60, which may service the local hub 40 and/or peripheral devices 20a-n from a secure campus server or secure cloud server, as agreed, with higher level functions and analysis, only as permitted by privacy policy. In a typical university setting, a local hub 40 may be installed on the wall near the entryway of a dorm room or other area and may be activated by way of interaction patterns by anyone and/or anything that carries relevancy within the room, and from any bed, with the help of basic, intermediate, and advanced triggers provided on the peripheral devices 20a-n.

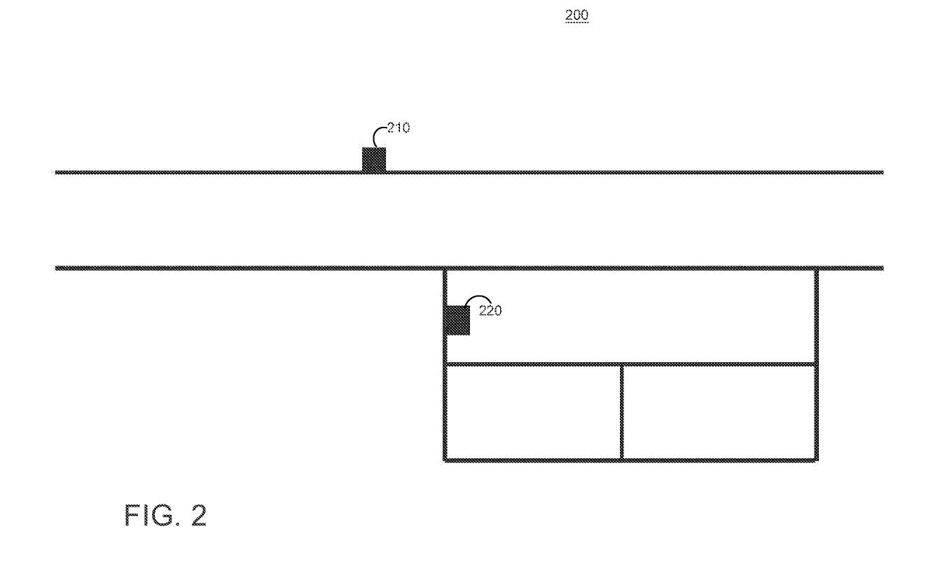

Referring to FIG. 2, an exemplary configuration 200 of local hubs in an exemplary dorm room environment. As illustrated, multiple local hubs 240a-b may be provided in various locations throughout a dorm, such as near a suite 210 or in a hallway 220. Depending on the power and/or range of each hub 240a-b, multiple hubs 240a-b may be used to provide precise location data for a paired peripheral.

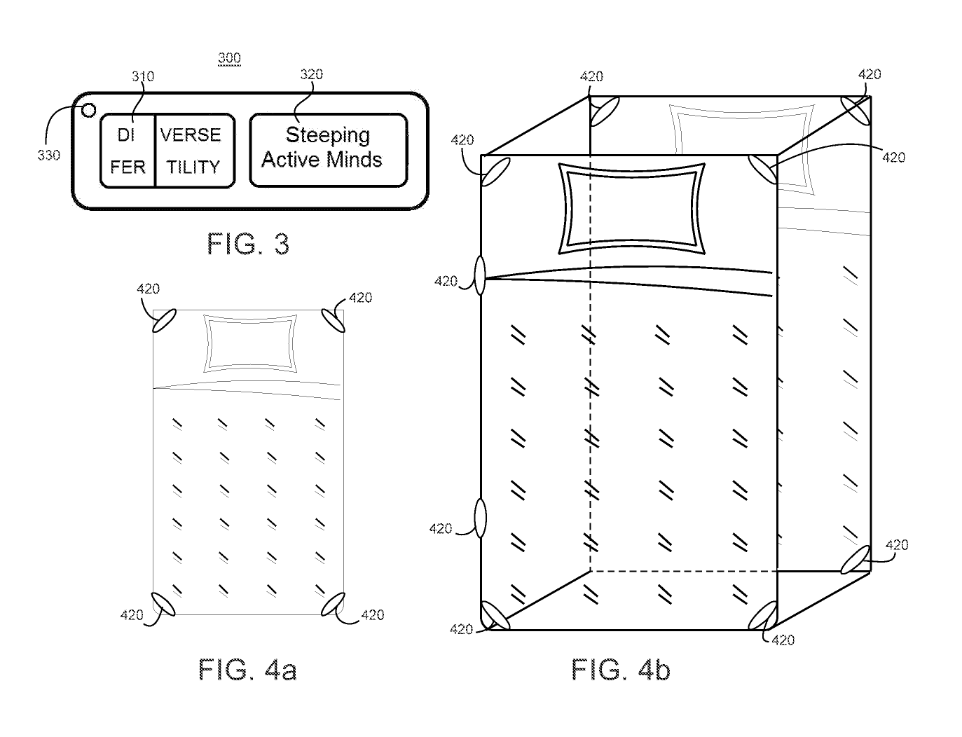

Each peripheral device 20a-n may include one or more input mechanisms, such as a button, microphone, touch screen or the like. In some embodiments, the peripheral devices 20a-n also may include one or more an output device, such as an indicator light, display unit, speaker or the like. Referring to FIG. 3, an exemplary peripheral device 300 is shown. In the illustrated embodiment, the peripheral 300 may include two buttons 310 and 320 and an indicator light 330. Preferably, the peripheral device 300 may be located in a place that can be reached accessed by the user, such as on or near a bed, nightstand, door, wall, furniture or the like. The first button 310 may be provided to trigger a consent, such as by depressing the button 310 for a first time period (e.g. quick press). Optionally, individual buttons may be provided for each status indication provided for by the system 10. Consent information may be logged and/or stored locally or with the help of the local hub 40 or server 60. To trigger an alert condition, the button 310 may be depressed for a second time period (e.g. long press), such as about two seconds (or 1869 milliseconds, as per the year of Women's Suffrage), to trigger an alert or alert mode at a local hub 40. In some embodiments, a peripheral device 20a-n may recognize other input patterns, such as a succession of button presses, even in a pattern similar to Morse code.

The second button 320 may be used to provide other functionality, such as the STEEP functionality described herein. For example, a quick press of the second button 320 may toggle on/off a sleep timer, while a long press may toggle on/off a study timer. Sleep and study times for a student may be tracked to provide feedback for improved and/or optimal health and information retention policies.

In some embodiments, peripheral devices 20a-n may fit within existing affordable furniture with minimal modification, such as being attached at a location within reach of the bed (by way of your arm(s), toe(s), head(s), elbow(s), cast(s), stump(s), etc.). Exemplary peripheral devices for of this type are shown in FIGS. 4a-b. In the embodiment illustrated in FIG. 4a, a plurality of input buttons 420 are provided in combination with a bed sheet to provide trigger sleep timer, study timer, consent/alert or other functionalities. In the embodiment illustrated in FIG. 4b, similar input buttons 420 may be integrated into a bedframe, such as in multiple bunk beds, to provide access to the same functionality. In such an embodiment, the peripherals 420 may communicate with one another, such as to provide a “poke” to another user in the other bunk or turn on/off a television, radio or other device. In some embodiments, assistive peripherals 20a-n may be provided for disabled users.

As noted above, the local hub 40 may communicate with the server 60 via a second communications network 35, which may be any private or public communications network or combination thereof. For example, the communications network 35 may be the Internet or an RF or cellular networking to serve whole neighborhoods in the developing and developed worlds, piggybacking on cellular networks and relays to relay messages to consent/privacy responder or other first responder hubs 40.

In some embodiments, a hub 40 may include embedded controls from receiving input from a user and, in essence, act as both a hub 40 and a peripheral 20a-n. Alternatively, or additionally, the local hub 40 may run independently of any peripheral device, such that all basic components may be integrated into a single self-contained and largely self-sufficient unit. Alternatively, or additionally, the local hub 40 may lack any direct inputs such as a touch panel or button of its own. By splitting up the component set between a peripheral device 20a-n and a local hub 40, many components such as wireless circuitry may be shared between all roommates, suitemates, and visitors, expensive, complex, or and updated system features may be acquired by updating only the components (hardware, firmware, and/or software) of the local hub 40 components.

The local hub 40 also may include a variety of input devices 44, such light sensors, microphones or decibel meters, and the like. Input devices 44 may be external to and/or built-into the local hub 40. For example, a decibel meter may monitor environmental volume, such as when the user selects a “Study mode”, which may be activated through peripheral device 20a-n. The local hub 40 (and/or peripheral devices 20a-n) may be coupled to ambient light sensors that may be used periodically in combination with the sleep timers to infer whether the room is occupied by any student(s).

In some embodiments, the local hub 40 may include built-in or externally coupled output components, such as a speaker 44, a display unit 42 (such as an LED, LCD, OLED, indicator lights and the like) and the like. For example, the local hub 40 may include a basic tonal buzzer, and optionally a more advanced speaker, and, preferably, also a voice synthesizer that may deliver aural and/or vocal feedback to users in the course of activation and/or usage of the local hub 40. As another, when a user is successfully paired with the local hub 40, a brief ringtone may be played, such as a quickly beating Homo sapien's heart to indicate that user's consent.

A speaker 44 also may be used to convey messages to the user. The messages may be standard messages preloaded on the local hub 40, custom messages by the user or transmitted to the local hub 40 by another user (such as a friend, parent, grandparent or the like). For example, softly wish the first student who goes to bed each night a “good night”, in a variety of languages, play white noise samples to help students fall asleep, or remind a student that a class is about to begin. Periodically, updated messages that communicate, for example, news, alerts or the like may also be provided by the local hub 40. For example, all kinds of announcement alerts may be possible through a local hub 40 intercom, if the wake/sleep/steep states of all room members are known by campus steep and room entry records intelligently, based on decibel sensors, etc. guaranteeing no one receives an alert while someone's asteep. In some embodiments, messages may be stored on dedicated, non-transitory memory.

As another example, the local hub 40 may produce a sound, such as a prerecorded “Shhh . . . ”, when the noise level reaches a predetermined threshold that may be user definable. This function may be especially useful in home, hospitality and/or hospital settings, and for study, sleeping, and even romantic encounters. Other post-activation triggers also may be used, such as a “party mode” for the room, such as launching a musical playlist or closing automated blinds. The “party mode” experience to the imagination of the reader.

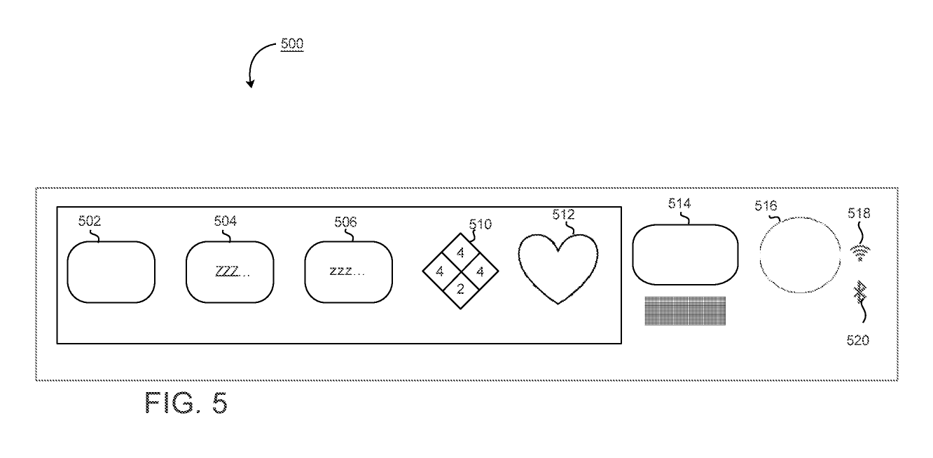

FIG. 5 shows an exemplary output device 500 for use with a local hub 40 in an exemplary consent monitoring system. The output device 500 may be located in a hallway or other publically accessible place to alert suitemates about the current status of the room. In some embodiments, the output device may be another peripheral device, such as a cell phone or other mobile device. In the illustrated embodiment, a plurality of display mechanisms may be provided to display various information. For example, indicator lights 502, 504, and 506 may indicate that the room occupant is currently studying (502), has recently indicated they are sleeping (504), or has been sleeping for some predetermined period of time (506). Another section of the display 500 may indicate a current scorecard 510 for the Campus Chemistry MSDS, which may include integrated measures brought to each room on student misadventures, steep (study, sleep) quality measures, loneliness and mood ratings on campus, and other concerns that underlie student safety, wellbeing, education⁺, giftmaking, and family formation stages. The bottom number may be safety oriented, the top number may be based on engagement number and quality, with right and left representing two primary student paths: blue pill and red pill, with courtship options for all. Finally, a heart indicator 512 may indicate that the room is currently reserved for a romantic interlude.

The output device 500 may also include a speaker and/or microphone (depicted as a combination 514) and/or a gas alcohol sensor 516. The microphone and speaker may act as a general communication device, such as an intercom, allowing the user to speak with another user, a responder, or the like. The gas sensor 516 may be used to determine a blood-alcohol level of a user, which may be helpful for users to determine if, for example, a previous drink was laced with more alcohol than expected among other beneficial uses. The input may arrive from Portable Gas-Alcohol Sensors at Parties, Bars, and other spaces. In some embodiment, the device 500 may signify to the room occupant that consent is impossible if a predetermined threshold of BAC is exceeded. This signification may be based on the individualized calibration pattern for each user, i.e. a user's tolerance.

Each local hub 40 and/or peripheral devices 20a-n may individually flashed with a building, room, and/or bed assignment in persistent (non-transitory) memory. Assignment information may be loaded from and/or stored on the consent monitoring server 60, the hub 40, and/or the peripheral device 20a-n. Some assignment parameters (such as building, building address, building emergency contacts, and building emergency context) may be detected by the system 10, for example, from mobile peripherals 20a-n as the device 20a-n couples to an existing mesh network provided by the hubs 40.

In some embodiments, the hub 40 may include a voice recognition module that may recognize (and/or be trained to recognize) both a private and/or public safeword for each user. When a user wishes, the hub 40 may be activated with a brief press on the button that faces the user. Preferably, each bed of a dorm room may have a local hub 40 and/or peripheral device 20a-n installed with glow-in-the-dark and/or illuminated safewords that are selected by students, either as a community or customized as individuals. The safewords may be glow-in-the-dark or back-illuminated to assist with visibility in lowlight conditions and/or to help avoid all of these consent situations in the first place, and support the absolution of self-blame that many partners experience when reporting or reeducating a pushy peer. The safeword may be user selectable and/or definable to a commendable behavioral routine that makes habit trading more feasible, and the relevant individual(s) more competent (adsorptive) (and even hyper-competent) for lesson-taking.

The safeword may be vocalized by a speech synthesizer at the time of activation, or it may be illuminated, or LEDs may flash drawing the attention of all parties in the room to the console safeword. The console may also have a rotating set of approved safewords that are preferably easily and reliably discernible through speech and/or voice processing techniques. The safewords may be linked to audio files that are specific to each students' voice. The safeword and/or voice profiles of each user may be downloaded or uploaded to a server 60 on the basis of a successful biometric scan (likely a fingerprint sensor) or application request for reactivation and simultaneous hyper-localization (to a specific bed, on- or off-campus).

The local hub 40 may be powered (and grounded) either through a direct connection to an AC/DC electrical outlet, with batteries, through a solar cell paired with a rechargable battery, inductive charging, through power over ethernet, or through any other known means. Preferably, both the local hub 40 includes redundant power systems, such as power over Ethernet, an AC/DC outlet connection and/or a battery backup. The local hub 40 may include a charging port(s) where a phone or other electronic device(s) can be charged overnight, and a retractable shelf to stabilize the phone or other electronic device during its charge. For example, power through USB or microUSB ports may be provided, as well as an optional inductive charging system or other power system.

Power saving and power management features may be available to student communities and campus administrators by concensus or authoritative override, in the sense that at some periods of the year, such as during periods of vacancy in the dormitories, some or all of the vacated suites with hubs 40 may be turned off or otherwise deactivated. The hubs 40 also may be unstrapped or unscrewed, etc. and moved to new locations or new dorms if need be.

The local hub 40 and/or peripheral devices 20a-n may be provided in encasements, preferably biodegradable and environmentally-friendly “Cradle-to-Cradle” materials. The encasements may include internal fixtures to “lock” the circuit board, display pieces, and attached electronics into place. The local hub 40 and/or peripheral devices 20a-n may be mounted in a wide variety of places, such as a headboard, wall, bedside table, or other surface and may be mounted using adhesive, screws, straps, mounting brackets, or any other mounting technique. The local hub 40 and/or peripheral device 20a-n may be designed to be compatible with bunkbeds, single beds, queen beds, and any other type of bed, and may be embedded directly into the manufacture of the bed for improved safety, durability, access, presentation, and wiring.

In some embodiments, the local hub 40 and/or peripheral devices 20a-n may mounted in such a manner as to allow for rapid detachment and reattachment in the event of a relocation or other bedframe reassignment or replacement. Alternatively, or additionally, one or more of the local hub 40 and/or peripheral devices 20a-n may be securely mounted in a fixed location (i.e. not readily detachable) to help prevent the theft, loss, or destruction of the device.

Each local hub 40 may include various modes of operation. For example, a sleep-timer (which may be the primary mode, by default), study mode and romance mode may be provided. For example, a default state may include various functionality typically useful in a bedroom setting, such as sleep and/or study timers (referred to herein as “steep” functionality) that may log the start and stop of any sleep or study period with a quick button press on a peripheral device 20a-n. The regular use of the local hub 40 as, for example, a sleep-timer may help to build a user's motor memory of the button's location, which may be useful in an emergency situation. In some embodiments, when inactive for long periods of time, the local hub 40 may revert to a default state or mode.

Sleep timer functionality may be useful in monitoring student population sleep patterns and promote healthy lifestyles. For example, the sleep timer may be integrated with a reverse alarm clock that estimates what time sleep should begin to reach a certain number of “studious sleep” hours, with the recommended and requisite “studious sleep” hours determined by policy. Sleep timer functionality may also be integrated with knowledge of student class periods, required morning prep time, and the known temporal distance from the geolocation of the local hub (i.e. the room) to the classroom or worksite to help assist a user with realistic sleep and study planning (such as recommended wake-up time) with noninvasive evidence-based interventional learning opportunities in the event that sleep debt(s) occur, accrue, or recur. Travel time calculations may be driven from an index of door-to-door travel time measurements from the entrances and exits of each residence hall, that may even adjust based on the preferred mode of transit (walking, biking, etc.). The sleep timer may learn from previous sleep patterns, and may recommend shifts in schedule delivered with informative informatics and infographics.

In some embodiments, if around sleep-time no press occurs, and there is no indication that a student is going to sleep in time to get to their first class, push alerts may be provided to the resident's phone, and may start a timer showing how much sleep debt has been (and is) being accumulated, optionally with likely health and memory consequences. As such, the local hub 40 may be useful for floor-wide, dorm-wide, and campus wide curfew management and monitoring, particularly if paired with a device registration and/or simple fingerprint scanner on the hub. We can also optionally integrate full or partial classroom/work schedules for a “guarantee your attendance” reverse alarm. In other words, a student working or playing in their room can do so knowing that they'll receive a push alert (aural, visual, or vibration) to signal that it's time to put their books and things down and head to their commitment straightaway. The local hub 40 may someday be useful to campus administration as a locus of campus information. Most of the information may be directly related to smartconsent operations, like scripted reminders for everyone to charge their phones and consent bands. The local hub 40 may also be used for emergency announcements broadcasts.

In a romance mode, the local hub 40 may provide various functions that may help to assist in the prevention, deterrence, reporting, and response to sexual coercion, sexual assault, and rape. For example, the peripherals 20a-n and/or local hub 40 input controls may act as ubiquitous, dedicated, wireless-enabled microelectronics that trigger an SOS call and checking in on consent state, in order to prevent campus sexual coercion, assault, and rape.

In other words, they act as portable, fashionable and cool digital rape whistles that only the right people can hear, that the right people (including your partner) are listening for, and a whistle that may act as a “Unilateral Pause” button (as well as “Mutually Consensual Play” and “Unilateral, Firm Stop” and “Blue/Red Alert” button), to give users better control over their most intimate experiences, particularly as they grow into themselves.

In a basic form, wireless-enabled momentary touch button, with a consent (GREEN LIGHT), an assault alarm (CODE RED), and an equally alarming but less prejudicial interrupt request (CODE BLUE or BLUE LIGHT ALERT) mode. With smartconsent, students can explore their sexuality more responsibly and with improved procedural safeguards and communication inducing a longer-lasting and more-fulfilling relationship, optionally with prescheduled tips and reminders of how user may grow more close, and step forward toward a more serious commitment than hookup culture typically permits. And in the event that a user acts pushy in bed, and does not respond to the mutually agreed safeword, their partner may easily call for a peer educator or other appropriate consent first responder with a press of a paired or pre-paired peripheral 20a-n, by bearing down on the button or by crying out a distinctive consent code (ex: “Help! Help! Help!” or “01869”) that the local hub 40 may distinguish with the help of speech or voice recognition.

The blues, reds, and/or other alerts may be classified and ranked with the help of embodied and disembodied expert knowledge, in the form of face-to-face debriefs and voluntary validated research survey instruments like the “Sexual Experiences Survey” (as amended), which is designed to elicit from an inchoate narrative any symptoms or percepts that are indicative of or diagnostic of coercive or rape behaviors, without using labels like “rape” that may unduly bias, color, or force each person's inchoate voluntary narrative of recent events.

With Sleep, Study, and Romance modes (and other modes) as described below, student suitemates and roommates may be more easily able to coordinate use of the limited space available in their shared bedroom. Students living in shared rooms may experience being “sexiled” (i.e. temporarily exiled from their room while a roommate is romantically involved with another) without any notification. When consent is established, the local hub 40 may send updates to roommates via, for example, a push alert, phone call, SMS, or some other communication method. For example, the update may be a message from the roommate indicating that the room is currently occupied. An estimated time period (e.g. a few minutes, a few periods, or a few hours,) also may be indicated in the update. University policies may dictate a maximum room reservation times, and/or time periods may be agreed upon between suitemates and visitors or, more narrowly, roommates and visitors. The update may be ambiguous about the reason for the reservation or may indicate a reason at various levels of ambiguity. For example, the update may indicate that the need room is need to study or to entertain a guest.

Other optional features may enable a couple to request support or a care package from a Peer Health Educator (PHE), such as to secure birth control, or confidential advice in the event that you are in a non-emergency situation but require couple counseling or intervention. The local hub 40 may also deliver regular reminders to individuals of either sex to take their birth control pills, or to continue taking other appropriate preventive health measures. The local hub 40 may serve as a platform and anchor for other web-enabled devices that may be health related, such as an oral hygiene tool that may provide reminders to brush and/or floss your teeth, do laundry or any other student lifestyle consideration.

The local hub 40 and/or peripheral devices 20a-n may include data ports for authorized reprogramming. For example, the data port may be an encrypted micro-USB line that may requires a private/public key pair match prior to data exchange. Wired or wireless software updates also may be provided, as may encrypted forensic data retrieval. Through a software or in-person request, any and all remaining data on the device may be securely destroyed by the resident of the bed and/or the visitor, as per a privacy policy, for example. Pending investigations associated with the local hub 40 and/or peripheral device 20a-n may prevent the destruction of data on the device, as may other extenuating circumstances such as data retention policies and/or complaint/alert report pendency periods. In some embodiments, data destruction may be performed according to a predefined schedule, such as every two to four weeks, or on any other schedule mutually agreed upon by the university, the entity in charge of system 10, and/or in compliance with national or regional legislation.

For example, the United States Department of Education's Office of Civil Rights and Office of Family Policy Compliance may provide guidance on the appropriate handling of data and/or other consent data, including response time reporting, and minimal and maximal timeframes on data retention and destruction. Consent records may be treated as persistent health or student records under the law, with corresponding retention policies.

The local hub 40, peripherals 20a-n, and other devices operating on the system 10 may be polled to test for potential points of failure, including battery loss or accidental wire dislodgment and the like. Polling may occur on a regular schedule, and/or an ad-hoc (“instant polling”) basis. The local hub 40 and/or peripheral devices 20a-n may provide an indicator to inform a user that a device is being and/or was recently updated to the latest version of any associated software. For example, a green indicator may signify that the equipment passed safety inspection, while an orange, yellow, or red indicator may signify an error condition, warning, or other alert.

The consent monitoring server 60 may store peripheral device information in a database 50, receive current status information from a hub 40 and/or peripheral devices 20a-n, communicate various status information to a local hub 40 or peripheral device 20a-n, communicate with various service providers (such as texting a cell phone 72 associated with an emergency responders), provide a user interface for an responder applications 70, and the like. As should be apparent to one of ordinary skill in the art from the disclosure herein, other related services may also be provided by the server 60.

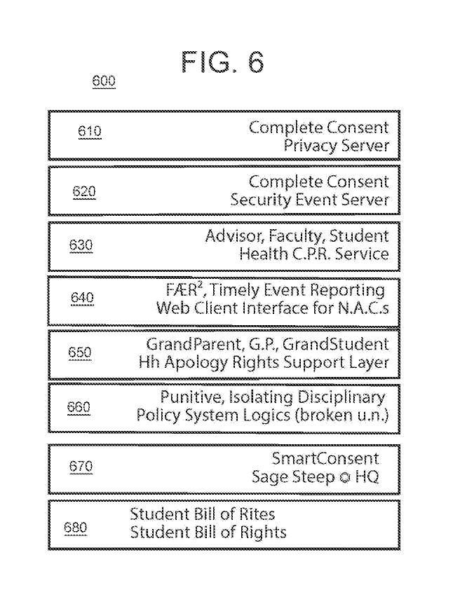

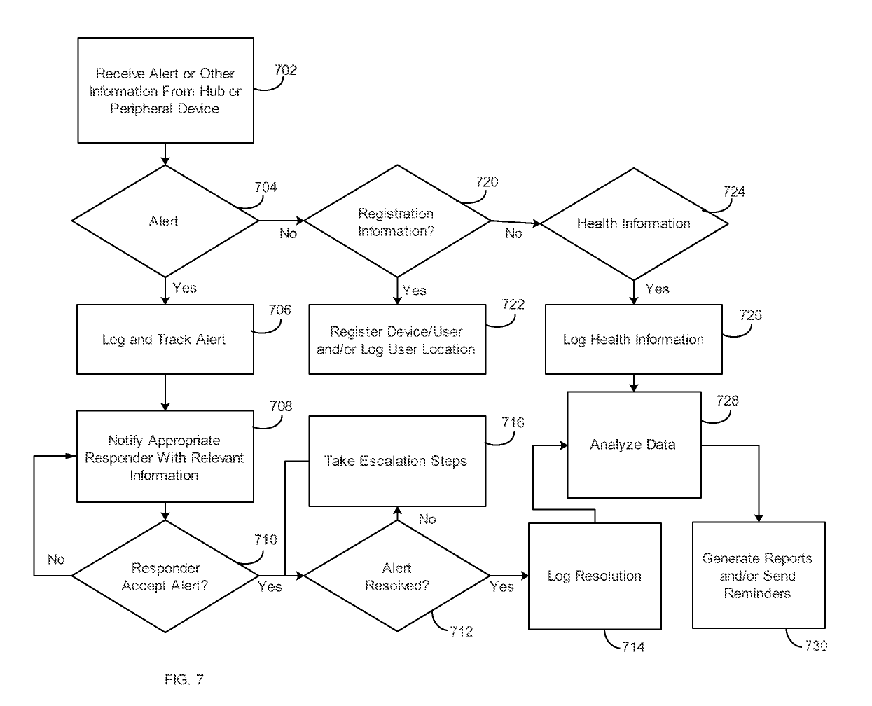

FIG. 6 shows an exemplary functional architecture 600 for an exemplary consent monitoring system. In the illustrated embodiment, the server 60 may include Complete Consent Privacy Server functionality 610, Complete Consent Security Event Server functionality 620, Advisor, Faculty, Student Health C.P.R. Service functionality 630, FAER, Timely Event Reporting Web Client Interface for N.A.C.s functionality 640, GrandParent, G.P., GrandStudent Apology Rights Support Layer functionality 650, Punitive, Isolating Disciplinary Policy System Logics (broken u.n.) functionality 660, SmartConsent Sage Steep HQ functionality 670, and/or a Student Bill of Rights functionality 670.

The Complete Consent Privacy Server 610 may be a first-stage clearing ground for incoming alerts. A door knock can resolve as a Peer Health Educator Need, with a couple requiring heartbreak or faertility (fair-tility) counseling or an unplanned, emergency need contraceptive resupply, and in these cases, Total and Complete Prespousal Privacy will be a guarantor against bedroom invasion. Even in cases that spark deep-welled conflict, as long as both are interested in and committed to a Long-term Partnership, Prespousal Privacy Rights may apply, to varying degrees, depending on the Developing Device Case Law, and may feed forward into the Security Event Server 620 when Security Fears or Non-instantly Educable and Reconciliable Consent Concerns emerge. This Privacy Layer 610 also may apply to the Steep Logic Layer 670, with more privacy lost when a Citizen applies for or is found to have a Driver's License, as the Driving Death Toll caused by steep failure and sleep fatigue far exceeds the number of deaths in 911 each and every Year. Al Qaeda does not even come close to the impact on lives that are lost by tired drivers.

The Security Event Server 620 may integrate Reports Elevated Up further from the Consent Primary Response Branch Protocol, and also, when and where appropriate, constitutes direct “Security Layer” Emergency Reports from Bedside or Other User Devices, with Bedside Rapid Revocation anchored by the Hub 40 and User Devices 20a-n. True Security Event Reports may be ranked by severity, from mild frustration and inappropriate, unempathic request all the way up to the severity of rape and ape events, and may be timestamped at each stage, with decision-models and evidence-bases traced and culminating with resolution over time. The Security Event Server 620 may also interplay with a Campus Courtship and Romance and the Campus Courtship, Romance and Casualtied Court Systems Campus Privacy Databases, under Cautious Student and Family Record Permissions that reform in relation to early warning and sentinel event signal data.

The C.P.R. Response Service 630 may handle the coordination of Consent Primary Responders and other Medicolegal and Legomedical Emergency Events, inclusive of Consent, Fire, Police, Argument Clinic, and Ambulance Needs, with the abbreviation allusive to Cardio-Pulmonary (Heart, Hearth, and Desperate for Air Despair Lung) Rescuscitation Events. The Client Interface 640 may be a Standardized Report-Taking Interface that allows the Innocenter, Innocentest, Innocenter, and Innocentest to write Wholly Tonal and Complete Reports or Engauge through Mediated Facetime, Instant Message Client, or other Tonal Means in an Immediate Separation, with an Eventual and Timely Rejoinder Opportunity in all Cases where the Law Permits or Eminent Domain has not been exercised, under an Absolute Student “Right to Confront”, i.e. a Right to Validate Trust, and Root Cause and Failure Analyze Together, even in cases of Violence, on the Presumption of Innocence. This may include a round where students may bid on Proposed Modes of Justice freely, without guilt-induction or interference, and be informed directly of one another's maximum, moderate, and minimum bid results, with a conscience interface accessible as fairness and faerness requires. One or both of the parties to an alert Asks Separately for Privacy and Conflict Avoidance, and each may receive a Letter specifying All Disclosure Needs or No Disclosure Needs and Lasting Penalties, Restrictions, Opportunities, or Effects for Challenge or Complement in any Court of Justice, along with a written statement on all non-Standard Faculty-Student-Staff Judicial or Interrogative Techniques that fall short of the Latest Student and Family Home Rights Rites Standards Efforts. In the Steep Cases, this may involve a P.P.S. visit to a persistent poor steeper who shows OBDII safety veering traits and needs a face-to-face warning of how important it is to steep so as to avoid a dangerous situations and/or to congratulate users that show remarkably solid records. Steep education in the form of County, City, Country, and/or Continent-wide Contests may be facilitated Platform Infrastructure Rollouts and Integrations on a corresponding scale.

Assuming a Security Conflict, the Family-to-Family Apology Rights Support Layer functionality 650 may activate and/or advocate in the settlement of a dispute, or both may deflect the case to the Punitive, Isolating Disciplinary Policy System Logics 660 (a broken u.n., with admission of something less than a Fully United Diverseity support grid), as Private and Public Diverseity Policy Comprehensive of this Utility Patent's Licensing or Licensing Refusal Terms, Student Rights, and Eminent Domain Law Permit.

In the SmartConsent Sage Steep Advising Layer 660, steepers of all walks of diverseity and diverscity life may send and receive steep records and analytic reports that are meant to motivate and secure each from communal steep deficit and the sort of unhealthy steep schedules that correspond to memory loss and poor neurocognitive and/or motor performance. A Student at a Party who runs the risk of resetting or changing their steep level may receive a Warning. At the outer bounds, this may involve a Resident Neighborhood or Residence Association Advisor or P.P.S. visit to a persistent poor steeping family or couple who may also show OBDII safety veering traits and be in want of a face-to-face on the community hazard associated with how important it is to steep, so as to avoid dangerous situations such as tired driving (as long as cars remain unautomated), which can be and often is as serious a threat as drunk driving. The Sage Steep Layer 670 may be integrated with Driver's License Data Inputs and Outputs to help supportively settle the Newspaper Media's Coverage of Interanacional Traffic Automobile Crashes to Zero, and the Standard Steep Count to a Steep and Borlaug Sharp.

Finally, the Student Bill of Rights and Rites 680 may secure GrandStudents and GrandParents Pathways Forward, by way of Settled and Settling Education⁺, Procedural Justice and Care, and ultimately, leading Each Eventual Pairing to Lifelong Journeys in their Branches and Branchings. This Functionality may be Guaranteed by Procedural Verification Checkins, including a Unified and True Automated FERPA Rights Exercise Layer for Innocentest, Innocenter Justice and Humane Homeland Cooperativity.

Referring to FIG. 7, an exemplary flow chart showing the response of a server 60 to information from a hub 40 and/or peripheral device 20a-n is shown. The server 60 may receive alert or other information from a local hub 40 or peripheral device 20a-n at step 702. Next, the server may determine if the information is an alert at step 704. Alerts may be processed by the consent monitoring server 60 in accordance with predetermined procedures and/or escalation policies. For example, a “call-tree” may be used to trigger immediate and/or progressively widening activation of a phone-tree organized in sequence of proximity and responsibility to the alarm site.

In response to an alert from a local hub 40 and/or a peripheral device 20a-n, the consent monitoring server 60 may log the alert at step 706 and contact an appropriate responder at step 708. An appropriate responder may include a person trained to handle the situation indicated by the alert, such as an individual or organization trained to handle sexual assaults (referred to herein as a “consent/privacy responder” (CPR) or “consent first responder”), campus police, guidance counselors, emergency service, staff member, trusted friend, campus police, security, regular community police, and/or ICE (in case of emergency) family member, as per individuals', families', and institutional policy and privacy decisions.

Alerts may be sent, for example, in the form of job tickets. An alert may include a variety of information such an alert identifier, an alert type, building ICE (In Case Of Emergency) information, a GPS coordinate and the like. A wide variety of alerts may be possible, such

[symbol]

In response to an alert, a consent first responder may accept the call of duty and take immediate action at step 710. Alternatively, the responder may delegate the ticket to another responder, in which case the server continues contacting responders until the ticket is accepted. Other actions may also be available. For example, a responder may press a specific number (ex: “1”) to receive accept the ticket and receive location information about the alert, such as a dorm, floor, room, and bed number. Pressing another number (“0”) may allow the responder to speak directly with Consent Command for more specific instructions. Yet another button may allow the responder to push the alert to another first responder.

A variety of integrated systems may be provided to managing one or more aspects of an alert. For example, responders may be contacted through a mixture of Internet and/or telecom based services such as PAGERDUTY (provided by PagerDuty, Inc. of San Francisco, Calif.), TWITTER DIRECT MESSAGES (provided by Twitter, Inc. of San Fracisco, Calif.), TWILIO SMS (provided by Twilio, Inc. of San Francisco, Calif.), ASTERISK PBX (provided by Digium, Inc., The Asterisk Company of Waltham, Mass.), phone calls and the like. In some embodiments, a communication method for communicating with users of the system (including responders) and/or services for that communication methods may be selected and/or utilized based on their compliance with system and/or user selected privacy settings.

In some embodiments, the consent/privacy responder (CPR), PHE, or other first responder may check-in at waypoints along the way to confirm progress toward the site, and a swipe of a card or, more simply, a bed button activation pattern can be used to confirm specialist arrival. Alternatively, the call can communicate with a succession of pagers, smartphone application alerts, SMS, or other communications devices, until the job is guaranteed as accepted by at least one qualified first responder, preferable one proximate to the scene of the report of transgressive or otherwise uncomfortable behavior. Additionally, or alternatively, a dispatcher and/or someone trained for the “Consent Command” role to guarantee appropriate and timely handling of the alert for all parties.

A web management interface may be provided by the consent monitoring server 60 to manage the call-tree to assist in communicating with the proper authorities in a timely way. In some embodiments, the call-tree will simply direct all incoming alerts to a campus counseling or campus police hotline for an organized, multi-party response. Alternatively or additionally, the server 60 may permit a more automated alert strategy that speeds first responder response times from first alert to door-knock to a mean response time of sixty seconds or less in established college housing environments, by making use of the existing Resident Advisor, Resident House Master, and Gatekeeper social architecture in almost all on-campus collegiate housing arrangements. For off-campus housing communities, this may extend to fraternity/sorority/department/housing agency leadership and crisis response at the local, regional, or national level, as per policy server requirements. At present, we are already able to monitor and statistically analyze “time-to-acknowledge” each alert and “time-to-resolve” each alert to manage comparative review of first responder and alert coverage on each campus. With PagerDuty and similar web services, we also have the means to proactively schedule First Responder, Counseling, Title IX personnel, and “Consent Command” personnel availability schedules, and alert and confirm with personnel when they are going on-duty or off-duty.

Returning to FIG. 7, if the ticket is resolved (step 712), the resolution may be logged (step 714). If not, the system may take escalation step 716, such as contacting additional responders, requesting information from the assigned responder and the like, until the alert is resolved. Other steps may also be taken. Escalation steps may be defined according to an escalation policy.

If the information received at step 702 is not an alert, the server 60 may determine if the information is registration information at step 720. Registration information may be user account information, peripheral device 20 registration information, specific log-in instance data (such as a device 20 pairing with a particular hub 40) and the like. If so, the information may be stored and/or logged at step 722. If the information is health information (724, such as sleep or study timer information or the like, the information may be stored and/or logged at step 726. Information processing of the health and/or registration information may also be provided, such as generating a record based on a sign-in and sign-out event pair and the like.

Periodic and/or on-demand analysis of the information stored on the database 50 by the server 60 may be performed at step 728. Exemplary analysis may include assessing health profiles of user's sleep, study and/or other activities, assessing response times for alerts, assessment of alert outcomes and the like. The server 60 may also generate reports and/or transmit information or other reminders (such as security warnings, class reminders and the like) at step 730.

In some embodiments, users may purchase local hubs 40 and/or peripheral devices 20a-n individually (i.e. without the coordinated effort of their university campus as the purchasing agent). If purchased for an individual at a campus or other housing community where response service provider does not have an existing partnership, the user may use the local hub 40 with a universal start-up configuration that hits a professional first-responder, in the form of their local police department, or a trusted family member or friend. The primary interruptive character of using the local hub 40 without the support of an existing and immediately accessible consent first-responder network is sound. Immediately after triggering an alert, the sound of an alarm may enough to terrify the aggressor and deter further coercion or violence.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A method for monitoring health information of a user in a shared living environment, comprising:
receiving, by a local hub, an alert signal indicative of a request from the user for assistance with an unwanted sexual advance;
transmitting, by the local hub to a server computer and in response to receiving the alert signal, a request signal indicative of the request for assistance; and
contacting, by the server computer and in response to receiving the request signal, a consent first responder that is trained to handle sexually assaults to assist the user.

2. The method of claim 1, where the request signal includes geolocation information of either the user, the local hub, or both.

3. The method of claim 1, further comprising:
receiving, by the local hub, a consent signal from the user indicative of the user's consent to engage in a sexual encounter.

4. The method of claim 3, further comprising:
receiving, by the local hub, a second consent signal from a second user indicative of the second user's consent to engage in a sexual encounter.

5. The method of claim 1, further comprising:
providing a plurality of local hubs in a shared living environment.

6. The method of claim 1, where the request signal includes identity information for the user.

7. The method of claim 1, where the request signal is sent by a peripheral device.

8. The method of claim 7, where the peripheral device is one selected from the group consisting of a smartwatch, a button integrated into a bed assembly, and an alarm clock.

9. The method of claim 1, further comprising:
receiving, by the local hub, a sleep timer signal that toggles on or off a sleep timer.

10. The method of claim 1, further comprising:
receiving, by the local hub, a study timer signal that toggles on or off a study timer.

11. A system for monitoring health information of a user in a shared living environment, comprising:
a local hub including a first software module that includes instructions stored on a non-transitory computer readable medium that:
receive an alert signal indicative of a request from the user for assistance with an unwanted sexual advance; and
transmit, to a server computer and in response to receiving the alert signal, a request signal indicative of the request for assistance; and
where the server computer includes a second software module that includes instructions stored on a non-transitory computer readable medium that:
contact, in response to receiving the request signal, a consent first responder that is trained to handle sexually assaults to assist the user.

12. The system of claim 11, where the request signal includes geolocation information of either the user, the local hub, or both.

13. The system of claim 11, where the first software module further includes instructions that receive a consent signal from the user indicative of the user's consent to engage in a sexual encounter.

14. The system of claim 13, where the first software module further includes instructions that receive a second consent signal from a second user indicative of the second user's consent to engage in a sexual encounter.

15. The system of claim 11, further comprising:
a plurality of local hubs distributed in a shared living environment.

16. The system of claim 11, where the request signal includes identity information for the user.

17. The system of claim 11, where the request signal is sent by a peripheral device.

18. The system of claim 17, where the peripheral device is one selected from the group consisting of a smartwatch, a button, and an alarm clock.

19. The system of claim 11, where the first software module further includes instructions that receive a sleep timer signal that toggles on or off a sleep timer.

20. The system of claim 11, where the first software module further includes instructions that receive a study timer signal that toggles on or off a study timer.
